(19) United States
(12) Patent Application Publication
(10) Pub. No.: US 2016/0162816 A1
(43) Pub. Date: Jun. 9, 2016

(54) HUMAN TASK MONITORING AND CONTEXTUAL ANALYSIS FOR DOMAIN-SPECIFIC BUSINESS PROCESSES

(71) Applicant: Xerox Corporation, Norwalk, CT (US)

(72) Inventors: Kunal Suri, Grenoble (FR); Adrian C. Mos, Meylan (FR)

(73) Assignee: Xerox Corporation

(21) Appl. No.: 14/560,293

(22) Filed: Dec. 4, 2014

(51) Int. Cl. G06Q 10/06

(52) U.S. Cl. CPC G06Q 10/0633

(57) ABSTRACT

a computer-implemented business process monitoring system includes a set of concept probes. Each concept probe is communicatively connected to a monitoring component of an associated business process management (BPM) infrastructure. In response to the BPM infrastructure deploying a domain-specific business process activity—including at least one manual task—each concept probe queries the BPM infrastructure for manual task information associated with execution of the business process activity. In response to receiving the manual task information from the BPM infrastructure and activity information acquired from an associated second probe connected to the BPM infrastructure, each concept probe correlates the manual task information with the activity information. Each concept probe generates monitoring information based on the correlated data.

### BACKGROUND

The exemplary embodiment is directed to monitoring of human tasks related to human-centric business processes in a service-oriented environment.

Business Process Management (BPM) and Service Oriented Architectures (SOA) are two significant aspects of business enterprise solutions. BPM addresses the methodology and tools that enable the management of domain-specific business processes (BPs) as they evolve throughout their lifecycles. A Business Process Management Suite (BPMS) is complex software stacks that execute business processes and connects them to various enterprise resources, such as a personnel directory, various legacy applications, and, in some cases, to the organization's SOA. An enterprise SOA typically manages the reusable technical services used to execute tasks that occur in business processes. Their functionality, granularity, and interfaces define their level of reuse across a multitude of business processes. In general, the closer the SOA services match the business requirements, the faster it is to implement new business processes. Any organization (“user”) that makes use of the BPMS tools needs to continuously monitor the execution of its various processes so as to determine if the processes are meeting expectations.

Business-oriented users typically use a language such as Business Process Model and Notation (BPMN) to describe a business process. Once the business process descriptions are created, a BPMN editor enables users to assign roles from the organization's hierarchy to human-actors, to generate forms for manual tasks, to write business rules in scripting languages to condition various execution flows, as well as to connect certain tasks to SOA services, among other features.

Once BPs have been designed and fully configured, they can be run by the BPMS. The BPMS manages execution of the BPs and also directs SOA calls to the appropriate SOA services, as required. Existing framework can extract information related to the execution of the BPs to determine, inter alia, whether the various activities execute correctly, execution times, the data passed between services, and whether pre-established thresholds for various parameters are exceeded. In this framework, information on the BPs is extracted using a monitoring infrastructure that connects to the BPMS and collects data as the BPs execute. Similarly, for SOA data collection, a monitoring infrastructure can obtain information from the execution environment, such as a specific enterprise service bus. The existing framework makes use of the monitoring data in order to present meaningful metrics to business users by, for example, correlating the execution of business concepts to the execution of services in the SOA layer.

The existing framework focuses on domain-specific processes consisting of automated activities that require no human- intervention, decisions, and intelligence to perform any task. In other words, this framework only exploits automated tasks correlating to services, but gives no consideration to the manual tasks of human-actors involved in a human-centric domain-specific business process. However, the most common business process—one that delivers a certain value to the end user—combines both manual activities/tasks (performed by human-actors) and automated activities/tasks (performed by web services and other automation technologies exposed as a service) to generate an outcome.

Particularly, in certain scenarios, execution of a manual task in a business process can be the weakest part of a chain. A Service Level Agreement (SLA) of a given business process is tightly coupled to the SLAs of individual activities that are involved in that process. If the organization fine-tunes the automated web services to work in accordance with its defined SLAs, for example by implementing advanced hardware, it may still fail to satisfy the SLA of the business process by missing an SLA stipulated for a human task involved in the business process. The monitoring of manual activities, in terms of their SLA restrictions, can provide organizations with intelligence about user activities and workload patterns over a period of time. These reporting mechanisms can help organizations understand factors which might be responsible for process inefficiencies, such as, for example the number of domain-specific responsibilities on a user, the number of users in the department with similar or higher capabilities, the priority of activities/tasks performed, and SLA time of tasks, etc.

There remains a need for an updated framework capable of monitoring both manual and automated activities, separately and/or in combination, in any domain-specific business process. Particularly, a framework is desired which monitors the human-centric business processes involving human activities along with integration-centric BPs involving SOAs.

### INCORPORATION BY REFERENCE

The disclosure of co-pending and commonly assigned U.S. application Ser. No. 13/963,240, entitled “MONITORING BUSINESS PROCESSES AND SERVICES USING CONCEPT PROBES AND BUSINESS PROCESS PROBES,” filed Aug. 9, 2013 by, Adrian C. Mos, the content of which is totally incorporated herein by reference.

### BRIEF DESCRIPTION

A first embodiment of the disclosure relates to a computer-implemented business process monitoring system. The system includes a set of concept probes. Each concept probe is communicatively connected to a monitoring component of an associated business process management (BPM) infrastructure. In response to the BPM infrastructure deploying a domain-specific business process activity—including at least one manual task—each concept probe queries the BPM infrastructure for manual task information associated with execution of the business process activity. In response to receiving the manual task information from the BPM infrastructure and activity information from an associated second probe connected to the BPM infrastructure, each concept probe correlates the manual task information with the activity information. Each concept probe generates monitoring information based on the correlated data.

Another embodiment of the disclosure relates to a computer-implemented method of monitoring a business process. For each domain-specific business process activity deployed in a BPM infrastructure, the method provides a concept probe implemented by a computer processor. The method includes communicatively connecting the concept probe to a monitoring component of an associated business process management (BPM) infrastructure. The method includes providing the concept probe with a mapping between the concept probe and manual task information associated with at least one manual task called on by the BPM infrastructure for execution of the business process activity. In response to receiving the manual task information from the BPM infrastructure and activity information acquired from an associated second probe connected to the BPM infrastructure, the method includes correlating the manual task information with the activity. The method further includes generating monitoring information based on the correlated data.

### BRIEF DESCRIPTION OF THE DRAWINGS

FIGS. 1A and 1B are functional block diagrams of a monitoring system in accordance with one aspect of the exemplary embodiment.

FIG. 2 is FIGS. 2A and 2B show a flowchart illustrating a method of monitoring a business process with concept probes and a business process probe in accordance with another aspect of the exemplary embodiment.

FIG. 3 is a functional block diagram of an example human-centric business process deployed into the BPMS and consisting of only manual activities.

FIG. 4 is a functional block diagram of an example domain-specific business process deployed into the BPMS and consisting of automated and manual activities.

FIG. 5 is a functional block diagram of an exemplary HTMCA component.

FIG. 6 illustrates an example scenario where an HTMCA component is implemented in a framework for monitoring a human-centric domain specific business process.

FIG. 7 shows a schematic interaction 700 is shown between a concept probe and various monitoring components of the BPMS.

FIG. 8 is a functional block diagram of an exemplary concept probe.

FIG. 9 is a functional block diagram of an exemplary business process probe.

FIG. 10 is a possible illustration of a usage scenario generated by the system of FIG. 1.

### DETAILED DESCRIPTION

The present disclosure is directed to a concept probe that monitors human tasks related to human-centric business processes in a service-oriented environment. The structure of the concept probe is improved over existing probes to take into account a human task monitoring and contextual analysis (“HTMCA”) component, which is responsible for monitoring workload distribution among human actors.

“Business process” is a systematic aggregation of various activities comprising of either manual activities, automated activities, or a combination of both manual and automated activities, all of which provide certain value to its end customer.

“Manual tasks” are activities/tasks involving human-actors that perform the task with the assistance of a software application or supervision of a computer/software application.

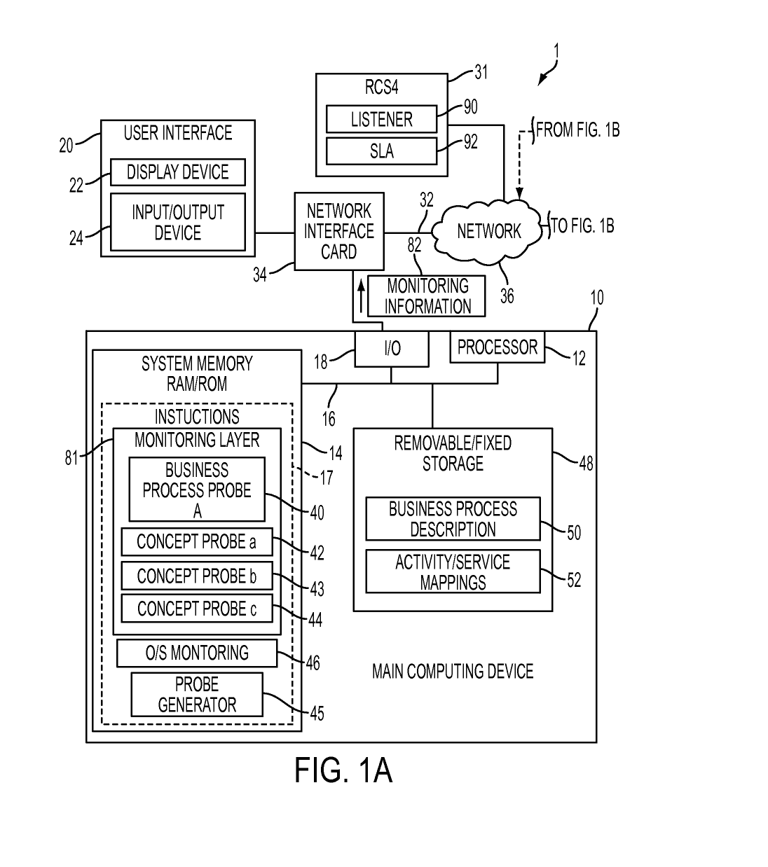

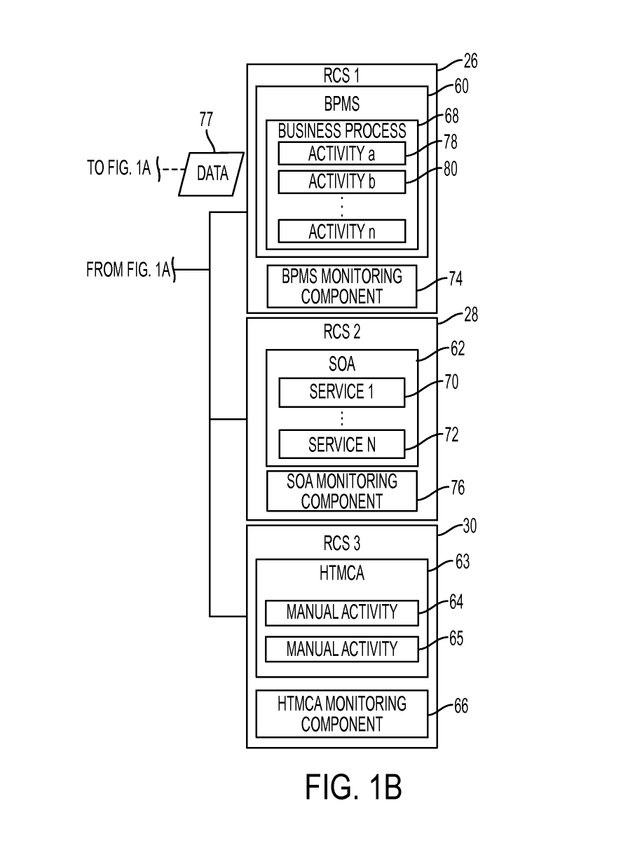

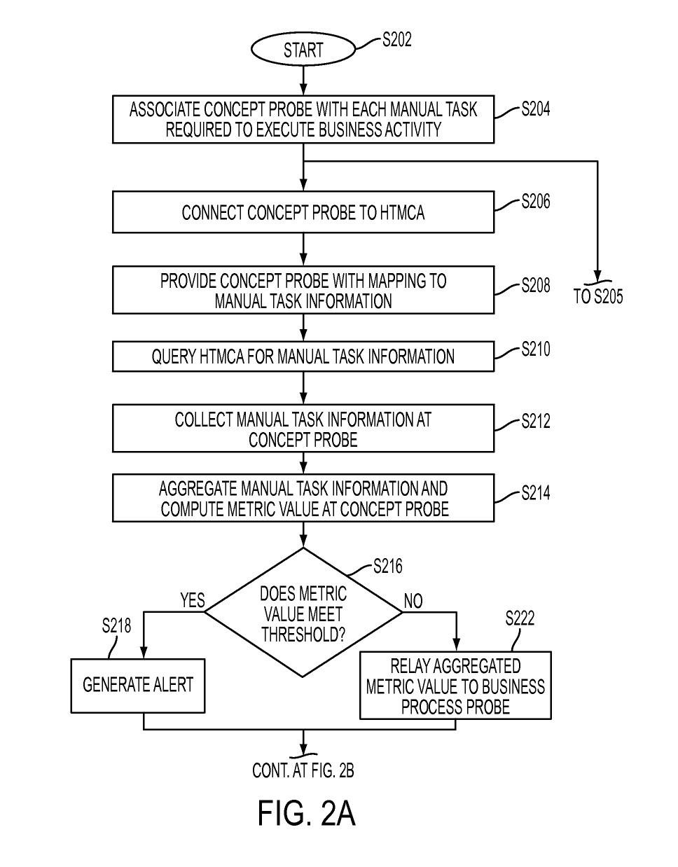

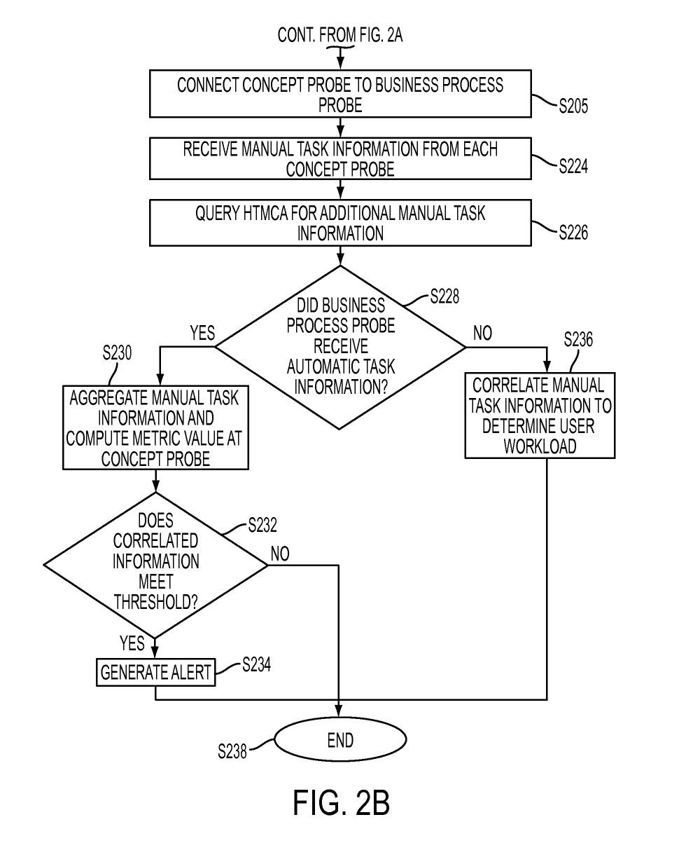

FIG. 1A-B is a functional block diagram of a computer-implemented monitoring system 1 suitable for performing the exemplary method disclosed herein. As will be appreciated, separate computer systems may be configured and connected for monitoring and for running individual services, activities, and processes. The illustrated monitoring system 1 includes a main computing device 10 including a processor 12, which controls the overall operation of the computing device 10 by execution of processing instructions which are stored in a memory 14 connected to the processor 12 by a bus 16. The processor 12 also executes instructions 17, stored in memory 14, for performing the exemplary method outlined in FIGS. 2A and 2B.

The monitoring system 1 may include multiple processors 12, wherein each processor is allocated to processing particular (sets of) instructions. Monitoring system 1 also includes one or more interfaces to connect the main computing device 10 to external devices, including an input output (I/O) interface 18. The I/O interface may communicate with a user interface 20. The user interface 20 may include one or more of a display device 22, for displaying information to users, such as an LCD screen, and a user input device 24, such as a keyboard or touch or writable screen, and/or a cursor control device, such as a mouse, trackball, or the like, for inputting instructions and communicating user input information and command selections to the processor. The I/O 18 also links the computing device 10 with external devices, such as the illustrated remote computing systems 26, 28, 30, and 31 via wired or wireless links 32. For example, I/O 18 may include or communicate with a network interface card (NIC) 34 which is in turn connected to a network 36, which links the main computing device to computing systems 26, 28, 30, and 31.

Memory 14 may store instructions 17 for executing various software components, such as a business process probe 40, a plurality of concept probes 42, 43, 44, which may be created at least partially automatically by a probe generator 45, and an operating system (O/S) monitoring service 46. These components may in turn be composed of other components, explained further below. The monitoring system 1 may also include a storage unit 48 which may be removable or fixed. The storage unit 48 may store, for example, data sufficient to load into memory a business process description 50 and activity/service mappings 52.

The main computing device 10 may include a PC, such as a desktop, a laptop, palmtop computer, portable digital assistant (PDA), server computer, cellular telephone, pager, or other computing device or devices capable of executing instructions for performing the exemplary method or methods described herein.

The memory 14 and storage unit 48 may be separate or combined and may each represent any type of non-transitory computer readable medium, such as random access memory (RAM), read only memory (ROM), magnetic disk or tape, optical disk, flash memory, or holographic memory. In one embodiment, the memory 14, 48 comprises a combination of random access memory and read only memory. In some embodiments, the processor 12 and memory 14 and/or storage unit 48 may be combined in a single chip.

The I/O interface 18 communicates with other devices via computer network 36, such as a local area network (LAN), a wide area network (WAN), or the Internet, and may comprise a modulator/demodulator (MODEM). The digital processor 12 can be variously embodied, such as by a single core processor, a dual core processor (or more generally by a multiple core processor), a digital processor and cooperating math coprocessor, a digital controller, or the like.

The term “software” as used herein is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on the server or other location to perform certain functions.

With reference to FIGS. 1A and 1B, the remote computing systems 26, 28, 30, and 31, which may be separate or combined, may be similarly configured to the main computing device 10, i.e., may include memory and a processor.

One or more of the remote computing systems (RCS 1) 26, may provide access to a business process modeling suite (BPMS) 60 which implements the business process description 50 by running a business process 68. The BPMS 60 may include an execution engine for executing Business Process Execution Language (BPEL) scripts, or another type of runtime engine. Another of the remote computing system(s) (RCS 2) 28, may provide access to a Service Oriented Architecture 62, providing the BPMS processes with access to services that execute the business process. The business process modeling suite (BPMS) 60 and the SOA 62 are described in co-pending and commonly assigned U.S. application Ser. No. 13/963,240 , entitled “MONITORING BUSINESS PROCESSES AND SERVICES USING CONCEPT PROBES AND BUSINESS PROCESS PROBES,” filed Aug. 9, 2013 by, Adrian C. Mos, the content of which is totally incorporated herein by reference. A detailed description of these remote computing systems is provided in the '240 application.

This present disclosure aims to extend the concept probe methodology discussed in the '240 application by introducing human task monitoring capabilities for all of the manual activities that are involved in a domain-specific business process in a BPMS. Mainly, the present disclosure provides another layer of human task monitoring on top the existing concept probe to help a user understand the patterns and behaviors of actors involved in any business process in an organization. Accordingly, FIG. 1B shows a remote computing system(s) (RCS 3) 30, may provide access to a human task monitoring and contextual analysis (“HTMCA”) component 63. The BPMS 60 includes a BPMS monitoring component 74 which monitors automated activities 78, 80, etc. The SOA 62 includes an SOA monitoring component 76 which monitors services 70, 72, etc. The BPMS monitoring component 74 and SOA monitoring component 76 provide automated monitoring data 77 to the business process probe 40 and concept probes 42, 43, 44 via network 36. The HTMCA component 63 includes a HTMCA monitoring component 66 which monitors manual activities 64, 65, etc.

The monitoring framework of FIGS. 1A and 1B provides a further monitoring layer 81 on top of the automated BPMS and SOA monitoring 74 components 74, 76 that includes a set of concept probes 42, 43, 44. Rather than relying on generic mechanisms to provide monitoring data, the monitoring layer 81 uses the concept probes to provide monitoring information 82. The concept probes match the business concepts used in the definition of the business activities which form the business processes. The concept probes combine monitoring information (i.e., automated and manual task information) from business process execution as well as service execution into aggregated information that is informative from a business concept point of view. This aggregated information 82 may be accessed by a listener component 90, which in turn can be accessed by a user via a user interface, such as interface 20. The listener component may evaluate compliance of the monitoring information with one or more rules, such as a service level agreement (SLA) rule 92. In one embodiment, the listener component may communicate the rule 92 to the business process probe 40 and/or a concept probe 42, 43, 44. The listener component registers the SLA rule 92 with the probe and receives/outputs an alert if the SLA rule 92 is violated.

This monitoring approach provides several advantages. First, it provides a much better understanding of the various execution parameters of the business concepts used in processes (including performance, correctness, and context). Second, it helps with setting application-wide alarms and constraints potentially corresponding to Service-Level-Agreements, on a concept-level. For a given concept, such constraints can be set-up with immediate effect in all the business processes that use the concept. Third, this approach gives technical users a deep understanding of the contribution of each of multiple application layers (BPMS, SOA, HTMCA, etc.) to the combined performance of a particular business concept, which can lead to rapid deployment of modifications to particular services, changes in business partners (that provide better services) or improvements in the underlying infrastructure or application parameters.

The concept probes may be configured to interface with the BPMS monitoring component 74 for automated task data collection. Similarly, for manual task data collection, the concept probes can connect to the HTMCA 63. Likewise, for SOA data collection, the concept probes can connect to the SOA monitoring layer 76 using, for example, a specific Enterprise Service Bus to collect metrics of interest.

FIG. 2A and 2B is a flowchart illustrating a method 200 of monitoring a business process with concept probes and a business process probe in accordance with another aspect of the exemplary embodiment. Referring to FIG. 2A, the method starts at S202. A concept probe is provided for each domain-specific business process activity deployed in a BPM infrastructure. More specifically, a concept probe is associated with each manual task required to execute the business process activity at S204. Next, the concept probe(s) is connected to at least one monitoring component—such as the HTMCA—of the BPM infrastructure at S206. At S208, the concept probe is provided with a mapping between the concept probe and manual task information associated with at least one manual task called on by the BPM infrastructure for execution of the business process activity. At S210, the concept probe queries for manual task information, including, for example, users of an entity employing the BPM infrastructure, roles of the users; and a combination of the above each associated with the business process activity. At S212, the concept probe collects the manual task information received from the BPM infrastructure. At S214, the concept probe aggregates the manual task information and computes a metric value with the aggregated information. At S216, the concept probe compares the metric value with a predetermined threshold. In response to the metric value meeting the threshold (YES at S216), the concept probe generates an alert at S218. In response to the metric value not meeting the threshold (NO at S216), the concept probe relays the manual task information to a business process probe at S222.

Continuing with FIG. 2B, simultaneously to or following the previous operations, the concept probe is communicatively connected to a business process probe at S205. At S224, the business process probe receives the manual task information from each concept probe. At S226, the business process probe queries the BPM infrastructure for additional information, such as tasks started and completed in a same time interval for executing the manual task-of-interest; tasks started before the manual task-of-interest and completed in the same time interval; tasks started after the manual task-of-interest and not completed in the same time interval; and/or tasks started before the manual-task-of-interest and not completed in the same time interval; etc. At S228, the business process probe determines if automatic task information is received. In the contemplated embodiment, automatic task information can include activity information acquired from a second probe connected to the BPM infrastructure. In another embodiment, the automatic task information can include both activity and service information each acquired from from additional probes connected to the BPM infrastructure. In response to receiving automatic task information (YES at S228), the business process probe aggregates/correlates the manual task information with the activity and/or service information at S230. At S232, the business process probe compares the correlated information with a predetermined threshold. In response to the threshold being met (YES at S232), the concept probe generates an alert at S234. In response to not receiving any additional automatic task information (NO at S228), the business process probe correlates the manual task information to determine a user's workload at any time interval at S236. The method ends at S238.

Although the control method 200 is illustrated and described above in the form of a series of acts or events, it will be appreciated that the various methods or processes of the present disclosure are not limited by the illustrated ordering of such acts or events. In this regard, except as specifically provided hereinafter, some acts or events may occur in different order and/or concurrently with other acts or events apart from those illustrated and described herein in accordance with the disclosure. It is further noted that not all illustrated steps may be required to implement a process or method in accordance with the present disclosure, and one or more such acts may be combined. The illustrated methods and other methods of the disclosure may be implemented in hardware, software, or combinations thereof, in order to provide the control functionality described herein, and may be employed in any system including but not limited to the above illustrated system 1, wherein the disclosure is not limited to the specific applications and embodiments illustrated and described herein.

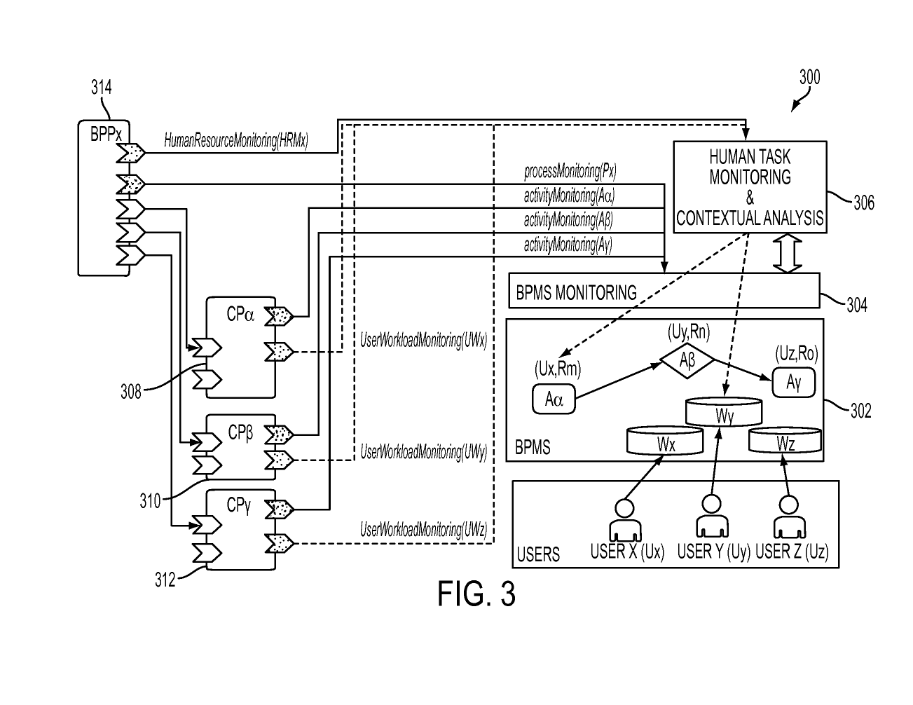

FIG. 3 illustrates an example of an “all-manual” human-centric business process 300 deployed into the BPMS monitoring component 302 and consisting of only manual activities given by ‘Aα’, ‘Aβ’, ‘Aγ’. Business process monitoring capabilities 304 are provided by the BPMS monitoring component 302 and can include, inter alia, the generation of events when activities execute, and the computation of execution times for, and the reporting of, various states in which the business processes operate. A human task monitoring and contextual analysis (“HTMCA”) component 306 stores knowledge about actors involved in the business process and the roles associated to each business process activity. In a domain-specific business process setting, the architect of the BP can define a number of roles having human actors. Each manual activity can be associated to a role, and each role can be assigned to a single human-actor or to a group of actors. Each actor can also have a work list of items s/he can selectively perform for the BP to work successfully in a stipulated time frame. The HTMCA component 306 has knowledge of this information, which is defined by the architect.

FIG. 3 illustrates three concept probes, CPα 308, CPβ 310, and CPγ 312, which each correspond to a respective business concepts α, β, γ used through activities ‘Aα’, ‘Aβ’, ‘Aγ’in the illustrated business process 300. In addition to the concept probes 308-312, a business process probe (“BPPx”) 314 can exchange information with the concept probes 308-312 to aggregate business process information. The concept probes 308-312 are in connected communication with the BPMS monitoring component 304.

In the illustrated example, each business concept probe 308-312 specifically interrogates the BPMS monitoring component 302 with regard to the events generated from the BPMS about the execution of its respective activity ‘Aα’, ‘Aβ’, ‘Aγ’. Each business concept probe 308-312 can also capture data from the HTMCA component 306 about the human-actors (Ux, Uy, Uz), roles (Rm, Rn, Ro), work lists assigned to the actors (Wx, Wy, Wz), and workload(s) corresponding with each manual activity that is involved in a business process. For example, a manual activity Aα can be assigned to a role ‘Rm’, which can be assigned to a single actor ‘Ux’; however, a single role R can be assigned to multiple users U and/or a single user can have many unique roles. The illustrated business process 300 shows manual activities Aα and Aβ performed by Role Rm and Rn and assigned to Users Ux and Uy, respectively.

In response 306 can provide a querying concept probe 308-312 (or business concept probe 314) with a list of all the business processes that the user can work on. This function provides these details at a macro level i.e. at business process level, rather than providing the details at a micro level for a manual task. In another example, the HTMCA 306 can provide the querying concept probe 308-312 (or business concept probe 314) with all roles the actor can perform or which are assigned to the actor. This function can be used at any time interval to determine the role-based load on the actor. This function can help determine if a particular user is too overburdened to perform a number of tasks. In response to receiving the user name and a time period as an input (from the BPMS 302), the HTMCA 306 can provide the querying concept probe 308-312 (or business concept probe 314) with details regarding the business processes that were executed by this actor in that time period. This function provides a detailed overview of the business process that the actor worked on, the activities s/he worked on, and relevant information about the activity, such as its execution time, etc. Another function can provide a detailed list of all the activities that are present in the worklist of a specific actor including activities that are incomplete. This function can be used to correlate the number of tasks active in a user's worklist and the amount of time those tasks have been active. Depending on the priority of any pending task, an alert can be generated for notifying the management about an actor's workload at any given time.

One example setting where this business process 300 can be deployed can include the distribution of courier mail. A distribution company guarantees delivery of items in a stipulated time frame. The company provides customers with a web portal to check the shipment status of mailed items using a unique tracking identification number. All of these services are automated, but the delivery step still involves a human actor to deliver the item at the named address. The concept probes 308-312 can gather information about the manual activities and the workloads associated with the delivery driver to determine how and/or if its shipments can be delivered quickly.

Another example setting where this business process 300 can be deployed can include a ‘leave approval’ process. In response to an employee applying for a leave, the BPMS 300—having previously acquired information corresponding to the role Rm of manager Ux associated with the approval activity—moves the application-for-leave to the manager's work list. And, in response to the manager approving the application-for-leave, the BPMS 300 moves the application-for-leave to the human resource's work list. The concept probes 308-312 can gather information about the manual activities and the workloads associated with the manager and the human resource personnel, which improve over existing framework. The concept probes 308-312 can apply contextual correlations to this data for obtaining various metrics.

Therefore, the disclosure makes it possible to correlate a user's workload, user's role-load, the deviation in the execution time of manual tasks, and that deviation's its correlation to the present user workload. The information generated by the present disclosures aids organizations in understanding execution patterns at the concept level for an activity in a domain-specific business process—such as the ‘leave approval’—that occurs across multiple departments of an organization, but which may differ between departments depending on the various departmental roles, users, and hierarchy, etc.

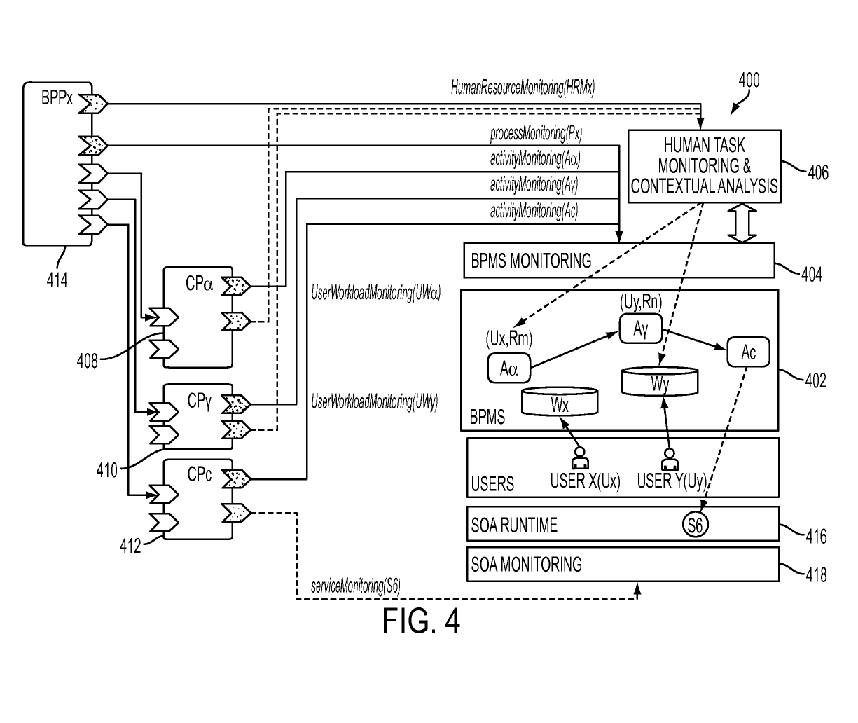

FIG. 4 illustrates a domain-specific business process 400 deployed in a BPMS monitoring component 402 consisting of manual activities and a SOA 416 consisting of automated activities. The business process 400 includes the BPMS monitoring component 402, monitoring capabilities 404 provided by the BPMS, concept probes, CPα 408, CPγ 410, and CPc 412, a business process probe (“BPPx”) 414, and a HTMCA component 406, all of which can be in connected communication with each other and each of which is analogous to the similarly-named devices described above for FIG. 3. The BPMS monitoring component 402 can also be connected to the services S6 in the SOA 416.

The illustrated SOA links can represent regular web service calls such as SOAP or RESTful invocations and are similar to the ones explained in disclosure of co-pending and commonly assigned U.S. application Ser. No. 13/963,240, entitled “MONITORING BUSINESS PROCESSES AND SERVICES USING CONCEPT PROBES AND BUSINESS PROCESS PROBES,” filed Aug. 9, 2013 by, Adrian C. Mos, the content of which is totally incorporated herein by reference. SOA monitoring capabilities 418 are provided by the SOA 416 and can include monitoring of, inter alia, service invocations, computing execution times for various service operations, and reporting of the states in which the services operate, etc.

In particular, illustrative activity Ac employs service S6—an automated task. The BPMS can acquire this knowledge, for example for concept C, from the concept mappings generated at design time. One concept probe CPc 412 can be associated with the automated service task S6 and can be in connected communication with the SOA 416 for aggregating BP-level information. In other words, the concept probe CPc 412 can interrogate the BPMS monitoring component 402 with regard to the activity Ac and the SOA monitoring component 416 with regard to services S6. Similarly, illustrated concept probes CPα and CPγ 408, 410 are associated with manual tasks and are connected to the HTMCA component 406. These concept probes CPα and CPγ 408, 410 can interrogate the HTMCA component 406 for acquiring user-centric information about respective activities Aα and Aγ.

The concept probes 408-412 leverage existing monitoring capabilities using specific bindings related to the concepts α, γ, c each probe needs to match. The concept probes 408-412 aggregate into meaningful information the required data from the various monitoring components, including the BPMS monitoring component 402, the SOA 416, and the HTMCA component 406. Similarly, the business process probes 414 aggregate the monitoring data from the concept probes 408-412 with additional BP-specific monitoring information generated by the BPMS monitoring component. This example is meant to illustrate the relationship between the concept probes 408-412, business process probes 414, the BPMS monitoring component 402, the SOA 416, and the HTMCA component 406. An actual business process may include more business activities, and a BPMS monitoring component 402 may host several business processes. Furthermore, other monitoring layers may be available in an enterprise environment, such as operating system monitoring, network monitoring, and cloud monitoring, etc.

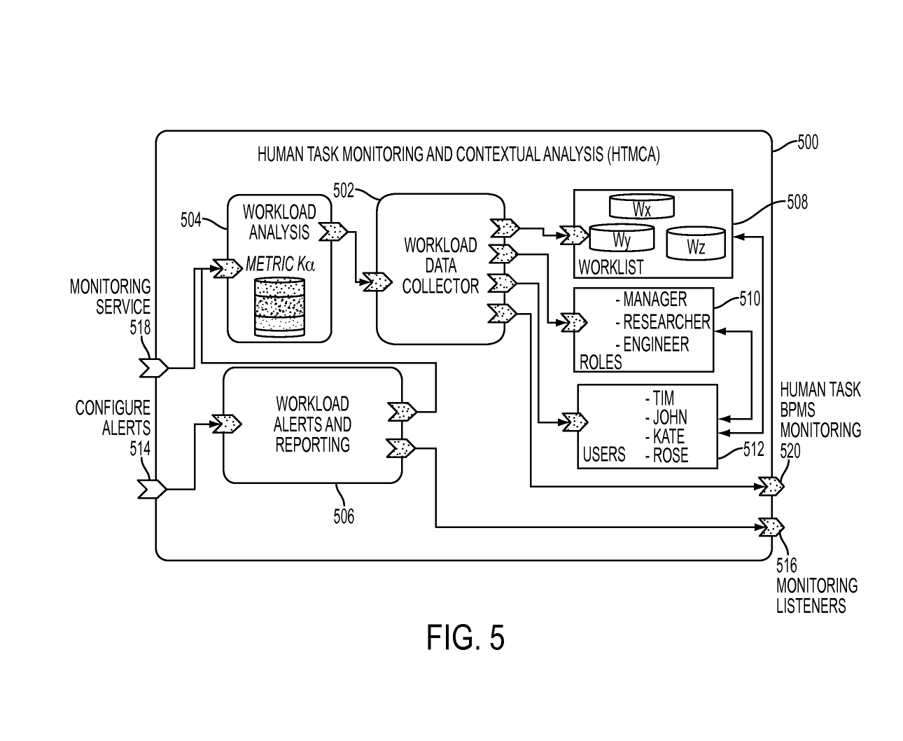

FIG. 5 shows the HTMCA component 500 (shown as 306 in FIGS. 3 and 406 in FIG. 4). The HTMCA component 500 includes a workload data collector 502, which collects data corresponding to the work list 508, roles 510, and users 512 available in a business process scenario. HTMCA component 500 is also in connected communication with the BPMS (not shown) to acquire data about the execution times of activities. The HTMCA component 500 further includes a workload analysis component 504, which aggregates raw data acquired from the workload data collector 502 into composite metrics. These composite metrics include data structures that aggregate the individual metric data for the BPMS and HTMCA component and present it as monitoring information to a concept probe (not shown) through monitoring port 520. The workload analysis component 504 may also be queried by outside clients for metric values via the monitoring service port 518 of the HTMCA component 500.

A workload alerts and reporting component 506 provides specific reports about the execution of the concept and alerting rules to registered listener components 516. These listeners 516 are external entities which can be connected to the HTMCA component 500 and be notified of important alerts and events through a configuration alerts port 514. Alerting and reporting component 506 also allows for the registration of service-level agreement (SLA) requests—which can set constraints on various roles—through the configure alerts port 514. The alerting and reporting component 506 compares aggregated metric values acquired from the workload analysis component 504 to thresholds of the SLA. Depending on the rules, the alerting and reporting component 506 may react to specified manual activities that are high in priority and/or require more attention. If the SLA thresholds are not met (e.g., exceeded in the case of execution time), the alerting and reporting component 506 may notify registered monitoring listener components via listener port 516.

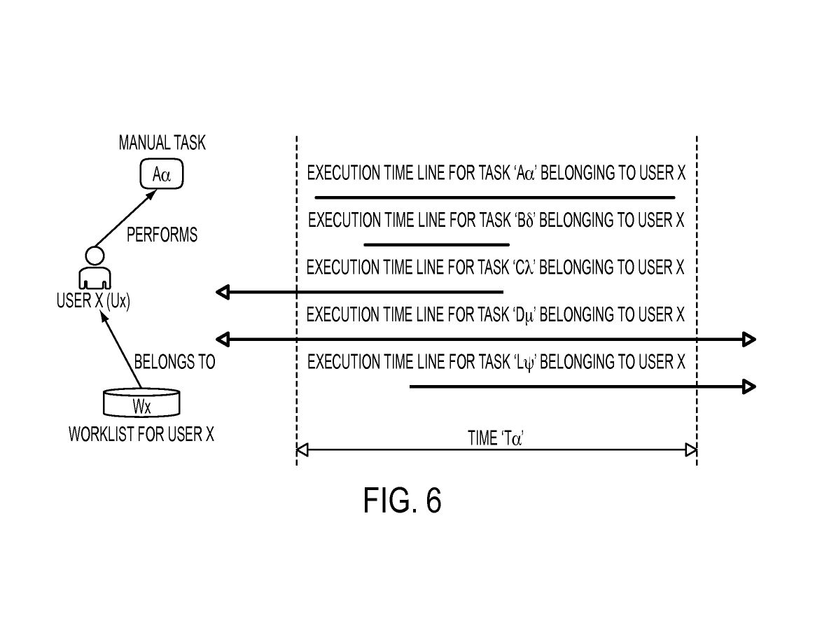

FIG. 6 illustrates an example scenario where an HTMCA component is implemented in a framework for monitoring a human-centric domain specific business process. In this example, an organization can desire to monitor its workload and the effect that workload has on user Ux assigned manual activity/task Aα. More particularly, the organization can monitor the effect that workload has on execution time Tα of the task Aα relative to other tasks Bδ, Cλ, Dμ, and Lψ also assigned to the same user Ux.

All the necessary information can be acquired by the concept probe CPα associated with the concept α. Particularly, the concept probe CPα (not shown) is in connected communication with the HTMCA component (500 in FIG. 5), which enables it to gather and correlate execution details of task Aα. FIG. 6 illustrates that at the time interval Tα that task Aα is being executed, the User Ux was and/or is working on various other activities/tasks Bδ, Cλ, Dμ, and Lψ. Some of these tasks Cλ, Dμ, were started before task Aαstarted its execution. Other ones of these tasks Bδ, Lψ were started during the execution of task Aα. Similarly, the concept probe Ca can provide information on tasks Bδ started and completed in the same time interval Tα, tasks Cλ started before but completed during the same time interval, tasks Dμ started before and completed after the same time interval, and tasks Lψ started during and completed after the same time interval.

Therefore, this contextually correlated information can help the organization discover the user workload at any time interval (such as Tα in the illustrated scenario), and it can assist the organization in understanding the cause of any delay with respect to other activities assigned to the user (which might be of higher priority), particularly where organizations have dozens, hundreds, and thousands of employees. Also, the organization can analyze the tasks and fine tune itself to remove performance bottlenecks by, for example, updating task priorities, assigning or reassigning the task Aα to additional and/or more suitable users, or creating new roles for complex tasks which require domain knowledge. The presently disclosed HTMCA component enables a quick and meaningful analysis of the manual activity be performed automatically and relatively instantly. One aspect of the HTMCA component is that it can provide an organization and its management with a clear picture of the workload, thus enabling performance enhancement.

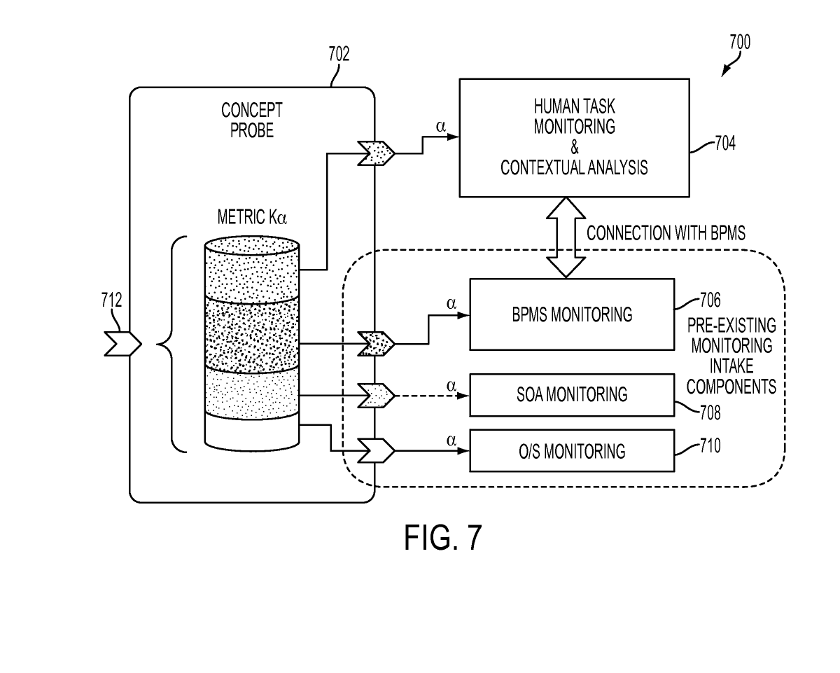

Continuing with FIG. 7, a schematic interaction 700 is shown between a concept probe and various monitoring components of the BPMS. FIG. 7 shows a simplified representation of concept probe 702. While the illustrated concept probe 702 only collects metric α data for composing metric Kα, embodiments are contemplated where the concept probe can collect several metrics. Metric α data is acquired from multiple monitoring systems 704-710 and then aggregated within the concept probe 702 to generate aggregate metric Kα information. The resulting information can be provided to clients, such as business process probe (414 in FIG. 4 and/or listener component) of the concept probe 702 via an interface 712.

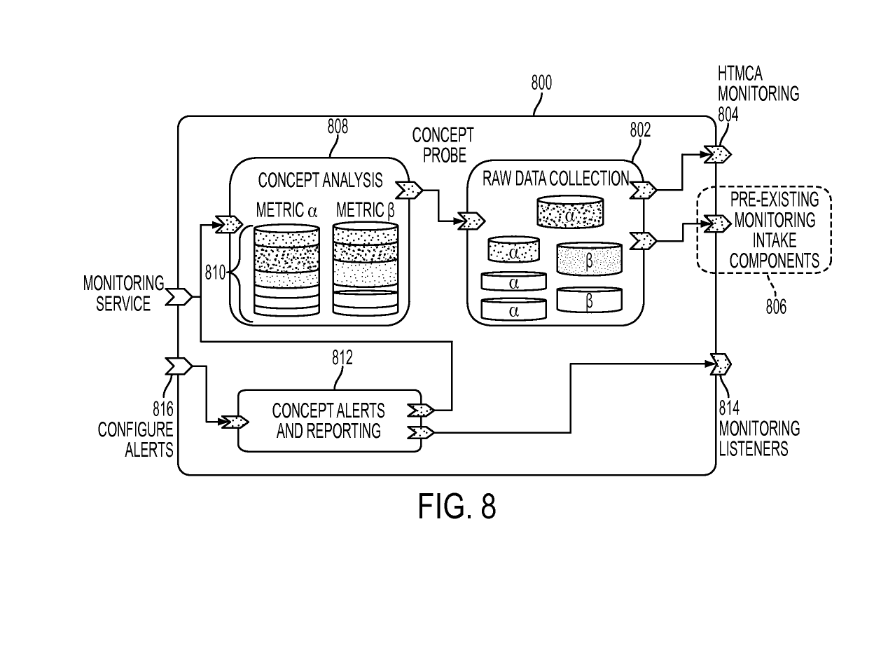

Principle components included in a concept probe 800 are shown in FIG. 8. A raw data collection component 802 collects data for a given metric from the collection inputs (communication interfaces). The raw data collection component 802 includes several data collection inputs 804, 806 each enabling the raw data collection component 802 to be in connected communication with a corresponding monitoring component, such as the HTMCA component, the BPMS monitoring component, and the SOA, etc. For illustration purposes, FIG. 8 shows that the raw data collection component 802 can collect data regarding manual activities for a given metric α and β from an HTMCA communication interface 804 and data regarding an automated activity for the given metric from a different monitoring component communication interface 806. There is no limit to the number of communication interlaces which connect the concept probe 800 to corresponding monitoring components. However, the embodiment contemplates that only one probe is associated with a concept, regardless of the number of manual activities that correspond with the concept. This approach emphasizes the value of monitoring each individual concept, regardless of where the concept falls within the business processes. Accordingly, each time an activity is executed, the concept probe, which corresponds to the concept associated with the activity, is notified.

Continuing with FIG. 8, the concept probe 800 also includes a concept analysis component 808, which aggregates the raw data acquired from the raw data collection component 802 into composite metrics (e.g., into metric α 810). These composite metrics are data structures that include an aggregate value computed for the individual metric data acquired from the HTMCA component, the BPMS, the SOA and other collection points. The concept analysis component 808 can generate the aggregate value, s.a., e.g., total execution time, as well as a breakdown of this value, and/or contextual information pertaining to the individual collection points. Example contextual information can include the individual execution time of services and of the process activity in the BPMS, as well as values for network latency, resource utilization in the application server or process scheduling in the operating system. For at least one of the concept probes, the computed aggregate metric value α or β is based on monitoring data acquired from the HTMCA monitoring component and—in response to receiving activity information and/or service information—at least one of the BPMS monitoring component and the SOA.

FIG. 8 further shows that the concept probe 800 includes a CP alerts and reporting component 812, which is analogous to the similarly-named component described for the HTMCA component in FIG. 5. The workload alerts and reporting component 812 provides specific reports about the execution of the concept and alerting rules to registered listener components. These listeners are external entities which can be connected to the concept probe 800 and be notified of important alerts and events through a configuration alerts port 814. CP alerting and reporting component 812 also allows for the registration of service-level agreement (SLA) requests—which can set constraints on various roles—through the configure alerts port 816. The CP alerting and reporting component 812 compares aggregated metric values acquired from the concept analysis component 808 with the thresholds of the SLA. If the SLA thresholds are not met (e.g., exceeded in the case of execution time), the CP alerting and reporting component 816 may notify registered monitoring listener components via listener port 814.

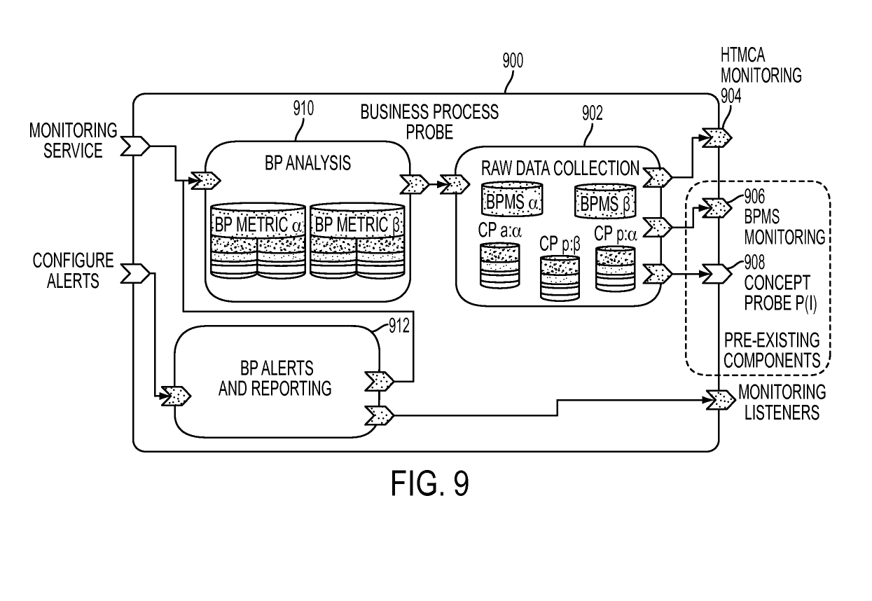

FIG. 9 illustrates the components of an exemplary business process probe 900. There is exactly one business process probe 900 associated with each deployed business process; however, the business process probe can be used for multiple deployments of its associated the business process. The business process probe 900 includes a BPP raw data collection component 902, which collects monitoring data from the different concept probes that each corresponds to the automated and/or manual activities of the business process being monitored by the business process probe 900. The BPP raw data collection component 902 includes several data collection inputs 904-908 each enabling the BPP raw data collection component 902 to be in connected communication with a corresponding component, such as a concept probe(s), the HTMCA component, the BPMS monitoring component, and the SOA, etc. For illustration purposes, FIG. 9 shows that BPP the raw data collection component 902 can acquire data regarding manual activities for a given metric BPMSα or BPMSβ (as well as metric values for the business process) from an BP HTMCA communication interface 904, and data regarding an automated activity for the given metric from a different monitoring component communication interface, such as the BPMS monitoring component interface 906, and aggregated monitoring information/metric values from a concept probe interface 908. There is no limit to the number of communication interfaces which connect the business process probe 900 to corresponding components.

Mainly, the BP raw data collection component 902 can include multiple concept probe interfaces 908 each connecting the business process probe 900 to a corresponding concept probe. The BPMS monitoring component interface 906 collects monitoring data for the execution of a corresponding business process in the BPMS. Example monitoring information can include contextual information (s.a., user name) for the required metric as well as metric values for the business process (s.a., e.g., execution time of the business process as seen from the BPMS).

The BP analysis component 910 is very similar in functionality to the concept analysis component 808 of the concept probe 800 (see FIG. 8), except that it aggregates data from the various concept probes and BPMS monitoring component for the whole process, rather than for each activity. To this end, the BP analysis component 910 aggregates the BPMS collected data—corresponding to the execution of the process—together with the previously aggregated data computed at and acquired from the various concept probes. A BP alerts and reporting component 912 has a similar function to the CP alerting and reporting component 812 (FIG. 8), except that it aggregates data from the BPMS, HTMCA and the various CPs for the whole business process.

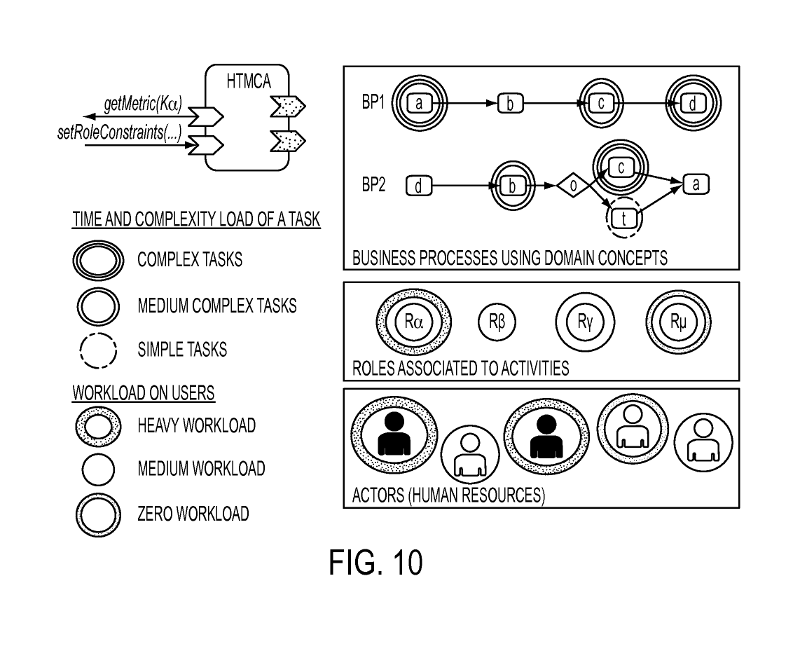

FIG. 10 is a visual representation of one of the example output that can be generated by the system (FIG. 1) including the HTMCA component for monitoring manual activities. As illustrated, the output can include detailed information about the various manual activities involved in the business processes BP1, BP2. The HTMCA has access to the worklist of each of the actors and can understand the workload on these actors. The HTMCA can utilize the Application programming interface (API's) exposed by a BPMS to achieve an understanding about the actors. By applying the metrics to various constraints set forth in the rules, the system can correlate information regarding the workload on various roles, the workload on various actors, time complexity, and task difficulty level to generate information about the task execution and its efficiency.

One aspect of the presently disclosed concept probe and its operation in conjunction with the HTMCA and corresponding framework is that it provides an ability to perform user-centric monitoring of domain-specific business processes, enabling an organization to better understand its human resources' work load, work patterns, behavior, and opportunities for fine-tuning its overall performance

The system can also help an organization discover and eliminate performance bottlenecks from its business processes, meet its SLA requirements, customer needs, and dynamic corporate competition. The present disclosure provides the organization-user with the ability to analyze manual task executions in context of its executor (human-user) and correlate the possible deviations in execution patterns to various factors, such as workload or task complexity. The system enables the organization to fine-tune itself by giving it knowledge of its human task force and factors such as excessive workload, reduced workforce that affect the working of the users in execution of its domain-specific business processes, etc. This knowledge may be extrapolated in future work to correlate to human-user stress associated with a manual activities—each dependent on factors such as priority and risk—in different department.

Another aspect of the present approach is that it is generic with respect to technology and domain-specific with respect to the business, thus improving on existing monitoring solutions. The concept monitoring probes can provide unprecedented insight into the execution of applications. The business users can understand how the processes execute in terms that are ideally suited to them. In addition, they can specify constraints and alerts for particular concepts that have immediate effect across the entire spectrum of the deployed business processes. It will help organizations to discover and fix the gaps in terms of user-centric management such as under and over utilization, process execution bottle necks and better work allocation mechanism.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A computer-implemented business process monitoring system comprising:
a set of concept probes, each concept probe being communicatively connected to a monitoring component of an associated business process management (BPM) infrastructure, wherein in response to the BPM infrastructure deploying a domain-specific business process activity including at least one manual task, the each concept probe queries the BPM infrastructure for manual task information associated with execution of the business process activity;
wherein in response to receiving the manual task information from the BPM infrastructure, and wherein in response to receiving activity information acquired from an associated second probe connected to the BPM infrastructure, the each concept probe correlates the manual task information with the activity; and,
wherein the each concept probe generates monitoring information based on the correlated data.

2. The system of claim 1, wherein the activity information includes data corresponding to execution of a respective activity which may be repeated across business processes.

3. The system of claim 1, wherein in response to receiving service information acquired from an associated third probe connected to the BPM infrastructure, the each concept probe correlates the manual task information with the activity information and the service information.

4. The system of claim 3, wherein the service information includes data corresponding to at least one technical service that is called by the BPM to execute the respective activity in a service oriented architecture (SOA).

5. The system of claim 1, wherein the each concept probe includes:
a workload data collector component collecting the manual task information received from the BPM infrastructure;
a workload analysis component aggregating the manual task information obtained from the workload data collector component and computing a metric value with the aggregated information; and,
a workload alert component comparing the metric value with a predetermined threshold and generating an alert in response to the metric value meeting the threshold.

6. The system of claim 1, wherein the each concept probe relays the manual task information to an associated business process probe.

7. The system of claim 1, wherein the each concept probe is further communicatively connected to a business process probe, the business process probe including:
a raw data collection component receiving the manual task information from the each concept probe;
an analysis component aggregating the manual task information with the Activity information to detect if a registered rule is violated; and
a concept alerts and reporting component generating an alert based on a detected rule violation and sends the alert to at least one associated registered listener component.

8. The system of claim 1, wherein in response to the BPM infrastructure deploying the domain-specific business process activity, the each concept probe querying the BPM infrastructure for data selected from a group consisting of:
the at least one manual task associated with the business process activity;
users of an entity employing the BPM infrastructure;
roles of the users; and,
a combination of the above each associated with the business process activity.

9. The system of claim 8, wherein the each concept probe correlates the data to determine a user's workload at any time interval.

10. The system of claim 8, wherein the each concept probe analyzes the user's worklist and the roles to generate the manual task information about activities assigned to the user.

11. The system of claim 8, wherein the each concept probe determines the user workload by querying the BPM infrastructure for tasks belonging to a user-of-interest including at least one of tasks started and completed in a same time interval for executing the manual task-of-interest; tasks started before the manual task-of-interest and completed in the same time interval; tasks started after the manual task-of-interest and not completed in the same time interval; tasks started before the manual-task-of-interest and not completed in the same time interval; tasks started

12. The system of claim 1, wherein one concept probe is associated with each manual task required to execute the business process activity.

13. A computer-implemented method of monitoring a business process, the method comprising:
for each domain-specific business process activity deployed in a BPM infrastructure, providing a concept probe implemented by a computer processor;
communicatively connecting the concept probe to a monitoring component of an associated business process management (BPM) infrastructure;
providing the concept probe with a mapping between the concept probe and manual task information associated with at least one manual task called on by the BPM infrastructure for execution of the business process activity;
wherein in response to receiving the manual task information from the BPM infrastructure, and wherein in response to receiving activity information acquired from an associated second probe connected to the BPM infrastructure, correlating the manual task information with the activity information; and,
generating monitoring information based on the correlated data.

14. The method of claim 13, further receiving service information acquired from a third probe connected to the BPM infrastructure.

15. The method of claim 14, wherein the activity information includes data corresponding to execution of a respective activity which may be repeated across business processes, and the service information includes data corresponding to at least one technical service that is called by the BPM to execute the respective activity in a service oriented architecture (SOA).

16. The method of claim 13, further comprising:
collecting the manual task information received from the BPM infrastructure at the concept probe;
aggregating the manual task information and computing a metric value with the aggregated information;
comparing the metric value with a predetermined threshold; and,
generating an alert in response to the metric value meeting the threshold.

17. The method of claim 13, further comprising:
relaying the manual task information to an associated business process probe.

18. The method of claim 13, further comprising:
communicatively connecting the concept probe to a business process probe including:
a raw data collection component receiving the manual task information from the each concept probe;
an analysis component aggregating the manual task information with the activity information to detect if a registered rule is violated; and
a concept alerts and reporting component generating an alert based on a detected rule violation and sends the alert to at least one associated registered listener component.

19. The method of claim 13, further comprising:
querying by the concept probe for data selected from a group consisting of:
the at least one manual task associated with the business process activity;
users of an entity employing the BPM infrastructure;
roles of the users; and,
a combination of the above each associated with the business process activity.

20. The method of claim 13, further comprising correlating the data to determine a user's workload at any time interval.

21. The method of claim 19, further comprising:
analyzing the user's worklist and the roles to generate the manual task information about activities assigned to the user.

22. The method of claim 21, further comprising determining the user workload by querying the BPM infrastructure for at least one of tasks started and completed in a same time interval for executing the manual task-of-interest; tasks started before the manual task-of-interest and completed in the same time interval; tasks started after the manual task-of-interest and not completed in the same time interval; tasks started before the manual-task-of-interest and not completed in the same time interval; tasks started

23. The method of claim 13, further comprising associating one concept probe with each manual task required to execute the business process activity.
